(19) United States
(12) Patent Application Publication
(10) Pub. No.: US 2011/0191427 A1
(43) Pub. Date: Aug. 4, 2011

(54) COMMUNICATION METHOD ADAPTED FOR USERS USING MULTIPLE COMMUNICATION FACILITIES

(75) Inventors: Johannes ELG, Helsingborg (SE); Johan KARLBERG, Lund (SE); Adam STELMACH, Malmo (SE); Linh TRANG, Akarp (SE)

(73) Assignee: Sony Ericsson Mobile Communications AB, Lund (SE)

(21) Appl. No.: 12/699,417

(22) Filed: Feb. 3, 2010

(51) Int. Cl. G06F 15/16

(52) U.S. Cl. 709/206

(57) ABSTRACT

A communication method for sending a message to an addressee using a first and second communication device of a user is disclosed. The method includes steps of, by the second communication device, determining that a message is to be sent from the user to the addressee, and sending, to the first communication device, at least part of the message; and steps of, by the first communication device, receiving, from the second communication device, the at least part of the message, and sending, to the addressee, the message with information identifying the first communication device as sender of the message. A communication method for receiving a message and replying thereto using a first and second communication device of a user is also disclosed. Communication devices, systems and computer programs adapted therefor are also disclosed

### TECHNICAL FIELD

The present invention relates to communication methods for sending a message to at least one addressee using multiple communication facilities of a user, or group of users. The communication facilities may, for instance, be telecommunications facilities such as mobile phones but are not limited thereto. The present invention also relates to communication methods for receiving a message and replying thereto using multiple communication facilities of a user, or group of users. The invention further relates to communication devices, computer programs, and computer-readable media including such programs.

### BACKGROUND

Many types of communication facilities, such as telecommunication facilities, messaging infrastructures and user interfaces, and mobile communication devices, exist. Those have often different features and capabilities, different shapes or sizes, etc. As a result, users increasingly use multiple communication facilities, sometimes simultaneously (e.g. one for work and one for private communications), sometimes for different occasions (one for normal use, one for going out).

There is a need for users to be able to use their multiple devices in a flexible and convenient manner.

Gmail, a webmail service by Google, includes a feature enabling an email message to be sent with, in the “From:” header of the message, an email address different from the user's Gmail address (see e.g. Heinz Tschabitscher, “How to Send Mail from Any Account, with Any Custom From: Address with Gmail”, About.com Guide, retrieved in December 2009 from http://email.about.com/od/gmailtips/qt/Send_Mail_from_Any_Account_Custom_F rom_Address_with_Gmail.htm?p=1) If an external SMTP server is associated with the email address, the email message can be sent through the external SMTP server instead of through the Gmail servers. Otherwise, when an email message is sent using an address different from the user's Gmail address through Gmail servers (instead of an external SMTP server set up for the address), Gmail adds the user's Gmail address in the message's “Sender:” header. It is reported that “Some recipients . . . may see your message coming from “ . . . @gmail.com; on behalf of . . . ” you at your other email address” (see above reference, last paragraph).

It is desirable to provide methods, devices, systems and computer programs to improve the communication, notably by allowing a more convenient and seamless use. It is also desirable to provide such methods, devices, systems and computer programs without requiring specific solutions to be implemented within the supporting network.

### SUMMARY

Such methods, devices, systems and computer programs are defined in the independent claims. Advantageous embodiments are defined in the dependent claims.

In one embodiment, a communication method for sending a message to at least one addressee using a first communication device of a user or group of users and a second communication device of the user or group of users is provided. The method includes steps of, by the second communication device, determining that a message is to be sent from the user or group of users to the at least one addressee; and sending, to the first communication device, at least part of the message; and the steps of, by the first communication device, receiving, from the second communication device, the at least part of the message; and sending, to the at least one addressee, the message with information identifying the first communication device as sender of the message.

The method therefore enables a user owning more than one communication device, including a first communication device and a second communication device, to carry only one of these communication devices and still be able to send a message to an addressee as if the message was sent using a communication device that the user is not currently carrying and using. Furthermore, the recipient of the message has no means to find out from the received message that the sender originally created the message using a communication device that is not the one which identity appears in the received message.

In particular, some communication devices—such as mobile communication devices bearing a subscriber identity module (SIM) cards storing a service subscriber key (such as an IMSI)—are only able to communicate in such a manner that the communication reveals the identity associated with the physical device. Therefore, with such devices, if a user owns a first device A, for instance used for business purposes, and a second communication device B, used for private purposes, the user would need to carry both devices at all time to be able to send a message to an addressee without confusing the addressee as to the origin of the message.

In other words, the method enables to send a message using the second communication device but in such a manner that, to the recipient, the message appears as originating from the first communication device. The recipient will therefore not be confused, and, moreover, the number and other characteristics of the second communication device will not be revealed to the recipient.

In the present context, a message is formatted unit of data or a group of formatted units of data capable of being carried through a communication network such as a computer network or a wireless radio network. The message has a sender and at least one addressee, i.e. the intended recipient(s). The invention may be applied to any such type of messages, such as short text messaging between mobile communications devices (such as SMS or MMS) or longer messages.

The first and second communication devices of the user or group of users may be mobile communication devices such as mobile phones, smart phones, personal digital assistants (PDAs), portable computers, portable game players, cameras, etc. The first and second communication devices each include a user interface for creating (e.g. writing) and gaining knowledge of (e.g. reading) messages, and a transmitter and a receiver for respectively transmitting and receiving messages. In one embodiment, the first and second communication devices are end user devices intended to be used exclusively by a user or group of users. In other words, in this embodiment, the first and second devices are personal communication devices, not servers or network nodes of a supporting core network.

In one embodiment, an identity is associated with the first communication device and an identity is associated with the second communication device. The two identities are different. The identities may be understood in a broad manner in the sense that they may cover characteristics of a message enabling to identify the communication device from which the message originates. In one embodiment, the identity associated with the first communication device is stored in its SIM card. In one embodiment, the identity associated with the second communication device is stored in its SIM card.

In the present context, a group of users may, for instance, be close relatives sharing a communication device. In one embodiment, the first and second communication device are owned and used exclusively, or substantially exclusively, by one user, not by a group of users. This embodiment may be combined with any other embodiment of the invention.

In one embodiment, the method further includes, between the steps of, by the second communication device, determining that a message is to be sent to the at least one addressee, and sending, to the first communication device, at least part of the message, a step of, by the second communication device, determining that the message has to be sent with information identifying the first communication device as sender of the message.

In this embodiment, after determining that a message is to be sent to at least one addressee, a determination is made as to whether the message should be sent by the second communication device to the first one in such a manner that, to the recipient, the message will appear as if it originates from the first device. The choice as to whether sending the message directly from the second device to the addressee or indirectly through the first device, so as for instance not to confuse the recipient, may be made through the selection by the user, in a user interface, of the particular communication device from which the message should appear to originate. That is, for instance, the user may select an originating communication device from a list of communication devices that the user owns.

The step of determining whether the message has to be sent with information identifying the first communication device as sender of the message may be carried out in accordance with alternative embodiments. In one embodiment, a user may set in advance that all messages to a particular addressee have to be sent with information identifying the first device as sender of the messages. The user may further set that all messages to be sent to another addressee are allowed to be sent directly from the second device, and therefore with information identifying the second device as sender.

In one embodiment, a user may activate a feature of a user interface so that, during a period of time, all the messages created using the second communication device are sent with information identifying the first communication device as sender of the message. In other words, during this period, the step of determining that a message has to be sent with information identifying the first device as sender can be dispensed with, since all the messages, during this period, will systematically be sent through the first device.

In one embodiment, a communication method for receiving a message and replying thereto using a first communication device of a user or group of users and a second communication device of the user or group of users is provided. The method includes steps of, by the first communication device, receiving an incoming message; determining that the user or group of users is currently not using the first device; sending, to the second communication device, at least part of the incoming message and an identifier of the first device; and a step of, by the second device, receiving, from the first device, the at least part of the incoming message and the identifier. The method further includes the communication method for sending a message to at least one addressee using a first communication device of a user or group of users and a second communication device of the user or group of users, as previously described, wherein the message is a response message in response to the incoming message.

In this embodiment, the communication method not only includes sending a message from the second device. Prior to this, the method includes receiving an incoming message through the first device. An identifier of the first device is included with the incoming message sent from the first to the second device. Thus, the second device, or the user using it, can determine or understand that the incoming message was originally received at the first device and, meanwhile, that the first device has determined that the user was not currently using the first device.

Therefore, the user receiving the incoming message on the second device can elect to reply thereto in such a manner that the response message is sent to the addressee with information identifying the first device as sender and that the response message is sent through the first device.

In one embodiment, the method is such that the identifier of the first communication device further identifies the incoming message.

This embodiment enables the response message to be sent back by the second device to the first device with the identifier identifying the incoming message. As a result, the first device is capable of processing the response message for it to appear as having been sent from the first device. For instance, if the original incoming message received at the first device was in a particular format which could not be properly received or properly rendered in the second device, the first device, when receiving the response message and the identifier of the incoming message, is capable of retrieving the format which was associated with the original incoming message in order to properly format the response message. In this manner, seamless processing is carried out in that the recipient is generally not able to find out that the message was created and originates from the second device rather than from the first one.

In one sub-embodiment of the previous embodiment, the step of sending, by the second to the first device, at least part of the response message includes sending the identifier.

This embodiment enables seamless processing of the response message in the first device. The step of including the identifier in the response message may be performed automatically, without requiring intervention of the user creating the response message through the user interface of the second device.

Alternatively, the user may select not to send the identifier with the response message and, in such a case, the first device may send the response message to the addressee as a new, default-formatted message, as if it originates from the first device.

In one embodiment, the method further includes, between the steps of, by the first device, receiving, from the second device, the at least part of the response message, and sending the response message to the at least one addressee with information identifying the first device as sender of the response message, steps of, by the first device, detecting the identifier sent with the at least part of the response message; retrieving a copy of the incoming message; and creating the response message based on the at least part of the response message received from the second device and based on the copy of the incoming message.

This embodiment reduces the quantity of required communication data between the second and first device when responding to a message. For instance, when originally receiving an incoming message, the first device may send a copy of the incoming message to the second device (if the first device determines that the user is not currently using the first device) after removing possibly unnecessary parts of the incoming message, such as attachments. The second device may then create and send a response message through the first device, whereas the first device retrieves the identifier of the incoming message and can transform the response message received from the second device into a response message with a format corresponding to a response message that would be sent directly from the first device.

In another embodiment, the whole incoming message is sent from the first to the second device, and, when sending a response back from the second to the first device, only the differences between the contents of the response message and the incoming message are sent from the second to the first device. Then, the first device adds the history of the thread to form a response message as if it originates from the first device.

In one embodiment, the method further includes, between the steps of, by the second device, receiving, from the first device, the at least part of the incoming message and the identifier; and determining that a response message is to be sent in response to the incoming message; a step of making available, by the second device, through a user interface thereof, the at least part of the incoming message. In this embodiment, the step of determining, by the second device, that a response message is to be sent in response to the incoming message is based on a user input on a user interface of the second device.

In this embodiment, the user is actively creating the response message on the user interface of the second device. In an alternative embodiment, an automatic response is sent by the second device without involving the user. The automatic response may be created in the second device, for instance based on rules in advance set by the user.

In one embodiment, the method is such that the step of determining, by the first device, that the user or group of users is currently not using the first device is based on a user-set parameter.

In this embodiment, the first device determines that the user or group of users is currently not using the first device by retrieving a user-set parameter. The parameter set by the user may be set in the first device (for instance when leaving behind the first device and going away for the weekend) or may be set by the user in the second communication device. In the latter case, the first device may query the second device to find out which communication device the user is currently using. The querying may be performed by the first device when receiving an incoming message. The querying may be directed not only to the second device but to all or some of the communication devices of the user or group of users.

The parameter set by the user to indicate which communication device is currently used may also be stored centrally in a database of the network.

In one embodiment, at least one of the first communication device and second communication device is a mobile device.

The invention also relates to a communication device, here referred to as second communication device, configured, in cooperation with another communication device, here referred to as first communication device, wherein both the first and second device are of the same user or group of users, for sending a message to at least one addressee. The second communication device includes a determiner and a sender. The determiner is configured for determining that a message is to be sent from the user or group of users to the at least one addressee. The sender is configured for sending, to the first communication device, at least part of the message.

The invention also relates to a communication device, here referred to as first communication device, configured, in cooperation with another communication device, here referred to as second communication device, wherein both the first and second device are of the same user or group of users, for sending a message to at least one addressee. The first communication device includes a receiver and a sender. The receiver is configured for receiving, from the second device, at least part of the message. The sender is configured for sending, to the at least one addressee, the message with information identifying the first device as sender of the message.

The invention also relates to a communication system including a first communication device as just described and a second communication device as just described.

In one embodiment, the communication system is such that the second communication device further includes a determiner, here referred to as second determiner. The second determiner is configured for determining that the message has to be sent with information identifying the first communication device as sender of the message.

In one embodiment, the invention also relates to a communication system for receiving a message and replying thereto using a first communication device of a user or group of users and a second communication device of the user or group of users. The first communication device includes a receiver, a determiner and a sender, here referred to as second sender. The receiver is configured for receiving an incoming message. The determiner is configured for determining that the user or group of users is currently not using the first device. The second sender is configured for sending, to the second communication device, at least part of the incoming message and an identifier of the first device. The second communication device includes a receiver. The receiver is configured for receiving, from the first device, the at least part of the incoming message and the identifier. The communication system further including the communication system as previously described (the communication system including the first communication device as then just described and the second communication device as then just described), wherein the message is a response message in response to the incoming message.

In one embodiment, the identifier of the first communication device further identifies the incoming message.

In one embodiment, the sender of the second device is further configured for sending, to the first device, the identifier with the at least part of the response message.

In one embodiment, the first device further includes a detector, a retriever, and a creator. The detector is configured for detecting the identifier sent with the at least part of the response message. The retriever is configured for retrieving a copy of the incoming message (originally received and stored in the first device). The creator is configured for creating the response message based on the at least part of the response message received from the second device and on the copy of the incoming message.

In one embodiment, the second device further includes a publisher. The publisher is configured for making available, by the second device, through a user interface thereof, the at least part of the incoming message. In this embodiment, the determiner of the second device is further configured for determining, based on an input on a user interface of the second device, that a response message is to be sent in response to the incoming message.

In one embodiment, the determiner of the first device is further configured for determining, based on a user-set parameter, that the user or group of users is currently not using the first device.

The invention also relates to a computer program including instructions configured, when executed on a communication device, to cause the communication device to carry out those steps to be performed by one of the first communication device and the second communication device in the communication method as described above. The invention also relates to a computer-readable medium storing such a program.

### BRIEF DESCRIPTION OF THE DRAWINGS

Embodiments of the present invention shall now be described, in conjunction with the appended figures, in which:

FIGS. 1a and 1b are flowcharts of communication methods for sending a message in embodiments of the invention;

FIGS. 2a to 2c are flowcharts of communication methods for receiving a message and replying thereto in embodiments of the invention;

FIGS. 3a and 3b schematically illustrate respectively a second communication device and a first communication device in embodiments of the invention;

FIG. 4 schematically illustrates a second communication device in one embodiment of the invention;

FIG. 5a schematically illustrates a second communication device in one embodiment of the invention, with a receiver for receiving at least part of an incoming message from a first communication device;

FIG. 5b schematically illustrates a first communication device in one embodiment of the invention, with a receiver, a determiner and a second sender for processing an incoming message;

FIG. 6a schematically illustrates a second communication device in one embodiment of the invention, configured for receiving an identifier with an incoming message and sending it back to the first communication device with the response message;

FIG. 6b schematically illustrates a first communication device in one embodiment of the invention, capable of receiving the response message and the identifier, and, based thereon, creating a response message to be sent to the at least one addressee;

FIG. 7 schematically illustrates a second communication device in one embodiment of the invention, configured for determining that a response message is to be sent based on a user interface input; and

FIG. 8 schematically illustrates a communication system including a first and second communication device, in one embodiment of the invention.

### DETAILED DESCRIPTION

The present invention shall now be described in conjunction with specific embodiments. These specific embodiments serve to provide the skilled person with a better understanding, but are not intended to in any way restrict the scope of the invention, which is defined by the appended claims.

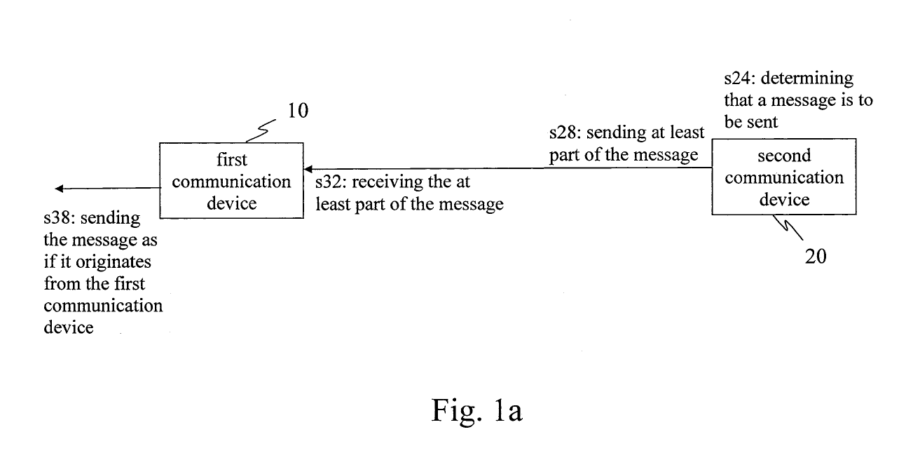

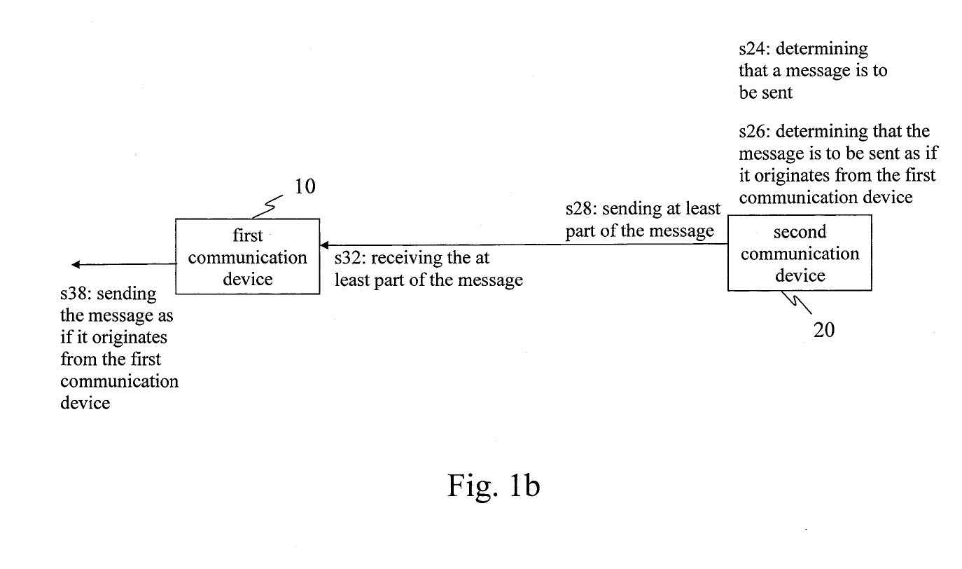

FIG. 1a is a flowchart of a communication method in one embodiment of invention. A first communication device 10 and a second communication device 20 are involved. The second device 20 is capable of sending messages directly to an addressee without the intervention of the first device 10. The first device 10 is also capable of sending messages directly to an addressee without the intervention of the second device 20. In that sense, both the first and second devices 10, 20 are independent communication devices.

However, in the present communication method, the second device 20 does not send the message directly to the addressee. The message is sent through the first device 10 to the addressee.

In particular, it is first determined s24 that a message is to be sent from a user or group of users to the at least one addressee. Based on a temporary configuration of the second device 20, at least part of the message (i.e. data constituting a portion of the message to be created and sent to the addressee) is sent s28 to the first device 10.

The first device 10 receives s32 the at least part of the message transmitted from the second device 20. The first device 10, in accordance with its configuration, then determines that the message is not addressed to the first device 10 (as final addressee) and that the message should be sent s38 as if it originates from the first device 10. The message is therefore sent s38 to the at least one addressee with the identity of the first device 10. The recipient receives the message as if it had been created in the first device 10. The recipient will therefore not be confused by the fact that the user is currently using the second device 20 rather than the first device 10.

The first device 10 thus acts in a non-conventional manner compared to what it usually does upon receiving a message. Normally, when the first device 10 receives a message, it activates its user interface to inform the user that a new message arrived. In the present method, however, the first device 10 detects the message or portion of the message coming from the second device 20 is a non-conventional message to be sent to an addressee which is not the first device 10. This detection step (not illustrated in FIG. 1a) may be performed by detecting in the portion of the message received from the second device 20 that the final addressee is not the first device 10, by detecting a particular flag in the data received from the second device 20, or by the current configuration state of the first device 10 which may such that that any message received by the first device 10 from the second device 20 during a period of time (for instance, during the period of time when the first device 10 is not in use) has to be sent to the addressee indicated in the received message transmitted from the second device 20.

The first device 10 performs step s32, of receiving the at least part of the message, and step s38, of sending the message as if it originates from the first device 10, without human intervention (i.e. based on rules or configuration).

FIG. 1b is a flowchart of a communication method for sending a message in accordance with another embodiment of the invention. The method illustrated in FIG. 1b differs from the one illustrated in FIG. 1a in that the second device 20, between steps s24 and s28, determines s26 that the message is to be sent as if it originates from the first device 10.

This determination in step s26 may be made based on a characteristic of the message to be sent, such as the addressee, or detection of keywords, such as for instance the word “confidential”, the name identifying a project, etc.

In one embodiment, the second device 20 is such that, during a period of time, all messages are to be sent as if they originate from the first device 10. Therefore, during this period of time, which may be set by the user, the result of step s26 is always positive and the first device 10 is always used as an intermediary device for sending the messages to the addressee(s).

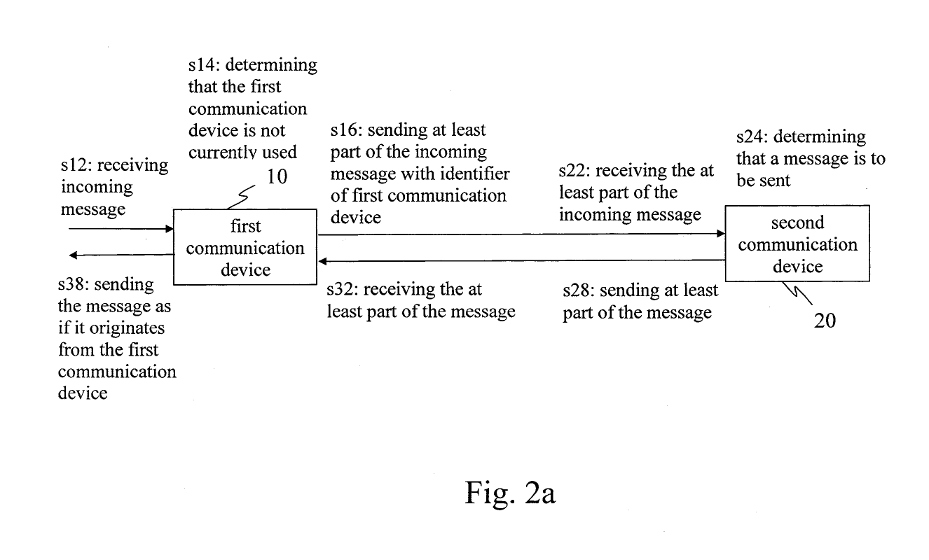

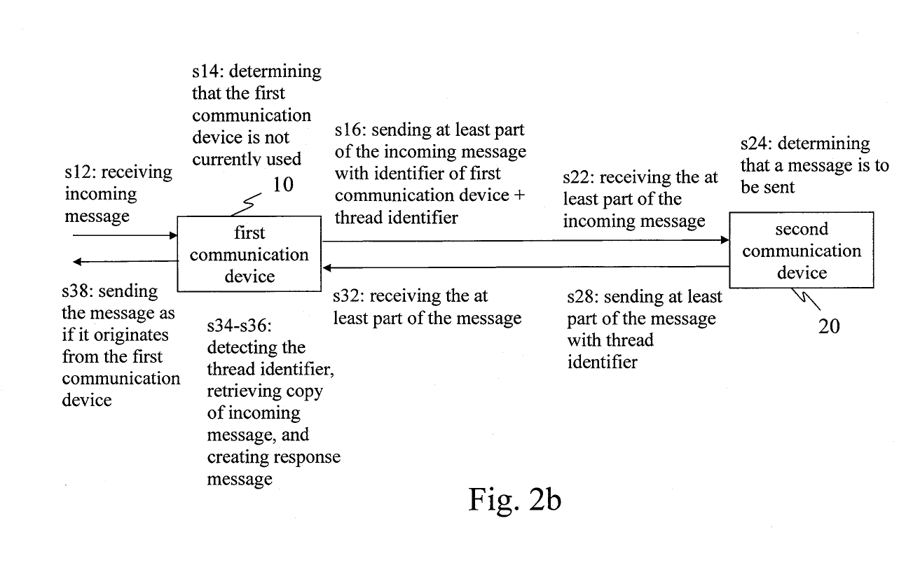

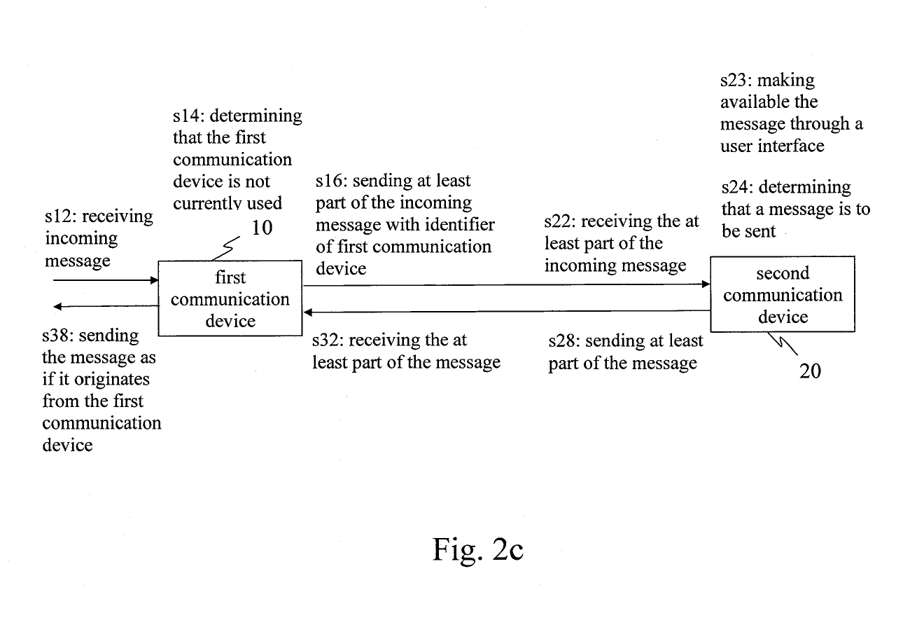

FIG. 2a is a flowchart of a communication method for receiving a message and replying thereto using a first communication device 10 and a second communication device 20, both of the same user or group of users.

In particular, the first device 10 receives s12 an incoming message. The first device 10 determines s14 that the first device 10 is not currently used by the user or group of users. The determination s14 may be made based on a parameter set by the user. The parameters set by the user to inform the first device 10 that the device is not currently in use may be set in the first device 10 or elsewhere, such as in a server (not illustrated) or in the second device 20. If the parameter indicating that the first device 10 is not currently in use is not stored within the first device 10, the device 10 may be required to query the network node wherein this information can be found.

After determining s14 that the first device 10 is currently not is use, the first device 10 sends s16 at least part of the incoming message with an identifier of the first device 10, to the second device 20. The at least part of the incoming message may be, for instance, only the title (such as the “subject:” field) or both the title and the contents without attachments or without pictures, or without certain types of pictures. This reduces the communication load between the first and second device 10, 20.

Then, the second device 20 receives s22 the at least part of the incoming message. The second device 20 determines s24 whether a message, i.e. a response message, is to be sent. If the result of step s24 is positive, the response message, which may have been created by the user of the second device 20 or may have been created automatically by the second device 20, is sent s28 to the first device 10. The second device 20 may send s28 only part of the response message.

The first device 10, upon receiving s32 the at least part of the response message, finalizes the response message to send s38 it as if it originates from the first device 10. The processing by the first device 10 may include adapting the format of the response message so that, to the recipient, it appears as originating from the first device 10 rather than from the second device 20.

FIG. 2b is a flowchart of a communication method for receiving a message and replying thereto, in another embodiment of the invention. The communication method illustrated in FIG. 2b differs from the one illustrated in FIG. 2a in that, in step s16, the first device 10 also sends an identifier of the incoming message or a thread identifier.

Furthermore, in step s28, the second device 20 sends the at least part of the response message with the message identifier or thread identifier. The first device 10 detects s34 the thread identifier or message identifier accompanying the at least part of the response message from the second device 20. It retrieves s35 a copy of the incoming message (originally received in step s12) and creates s36 a response message based on the at least part of the response message received in step s32 from the second device 20 and on the copy of the incoming message received in step s12.

This reduces the quantity of data exchanged between the first and second device 10, 20. Namely, in step s28, the second device 20 need not send a copy of the incoming message to the first device 10. Indeed, the first device 10 already received the incoming message in step s12 and had then an opportunity to make a copy thereof.

FIG. 2c is a flowchart of a communication method for receiving a message and replying thereto, in another embodiment of the invention. It differs from the method illustrated in FIG. 2a in that, between steps s22 and s24, the second device 20 makes available s23 the message through a user interface of the second device 20. Therefore, the user of the second device 20 is capable of deciding whether a response message is to be sent in response to the incoming message. The determination s24 is then made based on an interaction between the user and the user interface of the second device 20.

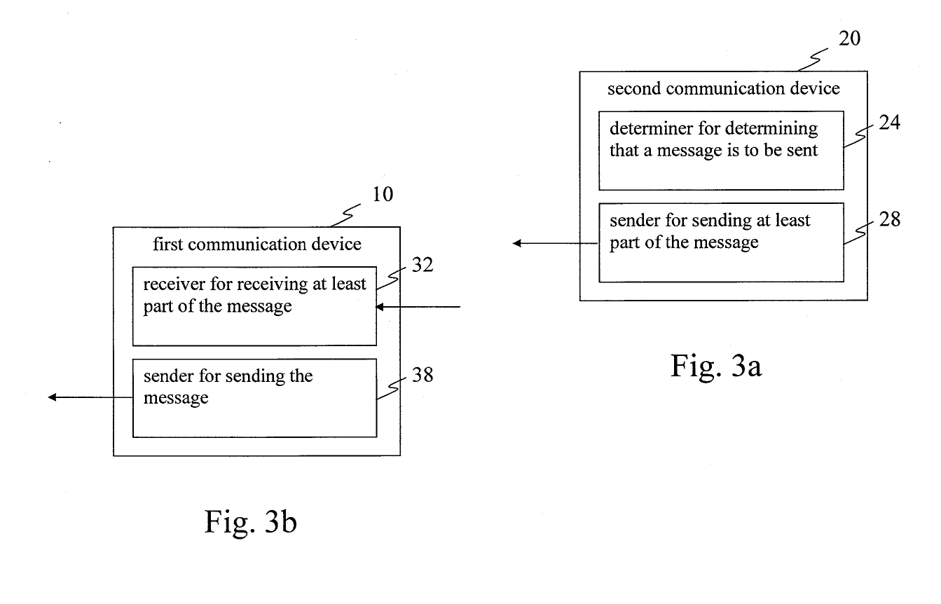

FIG. 3a schematically illustrates a second communication device 20 in one embodiment of the invention. The second device 20 is configured for sending a message to at least one addressee. It does so in cooperation with another communication device, namely a first communication device 10. The first communication device 10 and second communication device 20 belong to the same user or group of users. The second device 20 includes a determiner 24 and a sender 28. The determiner 24 is configured for determining that a message is to be sent from the user or group of users to the at least one addressee. The sender 28 is configured for sending at least a part of the message to the first device 10.

FIG. 3b schematically illustrates a first communication device 10 configured to cooperate with another communication device, namely a second communication device 20, for sending a message to at least one addressee. The first device 10 includes a receiver 32 configured for receiving at least part of the message to be sent to at least one addressee. The first device 10 also includes a sender 38 configured for sending the message to the at least one addressee, after converting the at least part of the message or completing it in order for the message to be as if it originates from the first device 10.

In one embodiment (not illustrated), a communication device includes the components of both a first and second communication device 10, 20. The communication device is thus capable of acting as first communication device 10 or as second communication device 20 depending, for instance, on whether the user is currently using the first or second device 10, 20.

Let us now describe exemplary scenarios wherein a user owns and uses both a business-dedicated mobile phone and a private mobile phone.

In a first exemplary scenario, the user installs the necessary software on the business mobile phone so that it can act as a first communication device 10. The user also installs on the private mobile phone the necessary software so that it can act as a second communication device 20.

The user goes away for the weekend with only his private mobile phone acting as a second communication device 20. If, when away for the weekend, with only the private mobile phone, the user wishes to send information to his or her boss or to a client, a message can be created using the private mobile phone (acting as second communication device 20). The user selects that the message is to be sent to the addressee (for instance, the boss or client) as if it originates from the business mobile phone (acting as first communication device 10). As a result, the recipient will be not be confused upon receiving the message since it appears to the recipient as having been sent by the business mobile phone rather than from the private mobile. Confusion is avoided. In addition, the user does not reveal his or her private mobile phone number that may be kept confidential.

In a second exemplary scenario, the user installs on the business mobile phone the necessary computer programs so that the business mobile phone is capable of acting as a second communication device 20. The user further installs on the private mobile phone the necessary computer programs for it to act as a first communication device 20.

When on a business trip, carrying only the business mobile phone, the user may wish to send a private message to a friend or relative, without confusing the friend or relative with a message that would indicate the user's business mobile phone number (which the friend or relative may not know). The user does so by creating the message to the friend or relative using the business mobile phone acting as a second device 20 by selecting that the message is to be sent as if it originates from the private mobile phone. The message is then sent (or part of the message is sent) to the private mobile phone, which may then for instance add a private signature or change the format of the message, and the private mobile phone acting as the first device 10 sends the message to the friend or relative, who is not confused.

In a third scenario, the user installs the necessary computer programs on both the business and private mobile phone so that both of them are capable of acting, whenever necessary, as first communication device 10 and second communication device 20. Depending on the time and circumstances and on the mobile phone that the user is currently carrying, the business mobile phone or private mobile phone may act as second device 20 while the other one acts as first device 10.

The invention is not limited to two communication devices. Three or more communication devices may be used and be involved in the communication method. Among those, a communication device may be programmed to be capable of acting as a first communication device 10, as a second communication device 20, or both as a first and second communication device 10, 20. There should be at least one communication device acting as second communication device 20 and one device acting as first communication device 10.

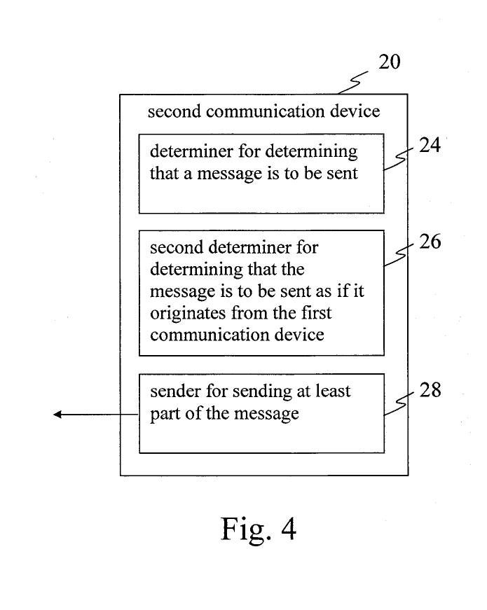

FIG. 4 schematically illustrates a second communication device 20 which differs from the one illustrated in FIG. 3a in that it includes a second determiner 26 configured for determining that the message is to be sent as if it originates from the first communication device 10.

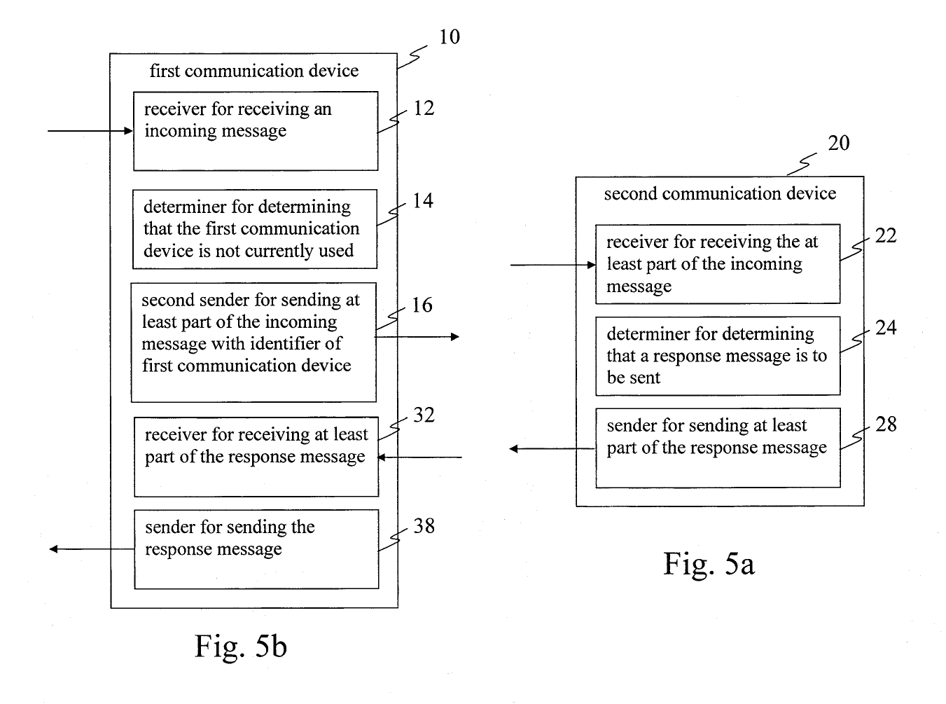

FIGS. 5a and 5b schematically illustrate a second communication device 20 and a first communication device 10 respectively, in one embodiment of the invention. The devices 10, 20 are configured to cooperate for receiving a message and replying thereto.

The first communication device 10 includes a receiver 12 configured for receiving an incoming message. The first device 10 also includes a determiner 14 configured for determining that the user or group of users is currently not using the first device 10. The first device 10 also includes a second sender 16 configured for sending at least part of the incoming message to the second communication device 20 with an identifier of the first device 10. The identifier of the first device 10 sent with the at least part of the incoming message from the first device 10 to the second device 20 enables the second device 20 to determine that the incoming message has arrived at the first device 10 and is therefore, for the second device 20, an indirect incoming message.

The second device 20 includes a receiver 22 configured for receiving from the first device 10 the at least part of the incoming message and the identifier.

The second device 20 further includes a determiner 24 and a sender 28, and the first device 10 further includes a receiver 32 and a sender 38. The description of these elements has been already made with reference to FIGS. 3a and 3b and equally applies to the embodiment illustrated in FIGS. 5a and 5b, except that the message is here a response message created in response to the incoming message.

Let us now describe further exemplary scenarios wherein a user owns and uses both a business-dedicated mobile phone and a private mobile phone.

In a fourth exemplary scenario, the user installs the necessary computer programs for the business mobile phone to act as a first communication device 10 and installs on the private mobile phone the necessary computer programs for it to act as a second communication device 20. When going away for the weekend with only the private mobile phone, the user sets his or her plurality of mobile phones in such a manner that the business mobile phone can find out that the user is currently not using the business mobile phone.

Then, a business-related message is received on the business mobile phone acting as the first communication device 10. The business mobile phone determines that it is currently not in use and thus sends at least part of the business-related message to the private mobile phone. The private mobile phone acting as a second communication device 20 determines that a response message is to be sent to the incoming message. The determination may be made, for instance, by publishing at least part of the message on a user interface accessible to the user and detecting a user input. Then, a response message or at least part thereof is sent from the private mobile phone to the business mobile phone, which transforms the response message or completes it, so that the response message is as if it had been originally sent by the business mobile phone.

The same type of scenario can be applied when the private mobile phone acts as first device 10 and the business mobile phone acts as second device 20.

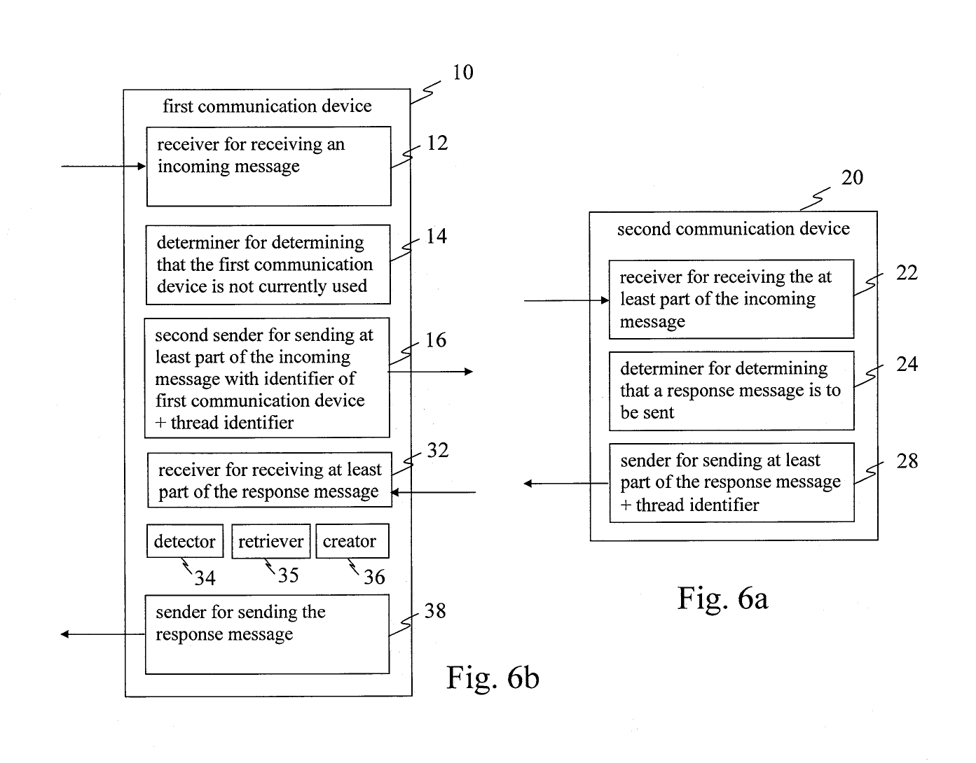

FIGS. 6a and 6b schematically illustrate respectively a second communication device 20 and a first communication device 10 in one embodiment of the invention. These devices 10, 20 differ from those illustrated in FIGS. 5a and 5b in that, when the second sender 16 of the first device 10 sends at least part of the incoming message to the second device 20, it includes a message or thread identifier. The second device 20, when returning a response message to the first device 10, also includes the message or thread identifier. This enables the first device 10 to use the detector 34 to detect the identifier sent with the at least part of the response message. A retriever 34 is then configured for retrieving a copy of the incoming message. A creator 36 then creates a response message based on the at least part of the response message received from the second device 20 and based on the copy of the incoming message. This embodiment reduces the quantity of data exchanged between the first and second devices 10, 20, as explained above with reference to FIG. 2b.

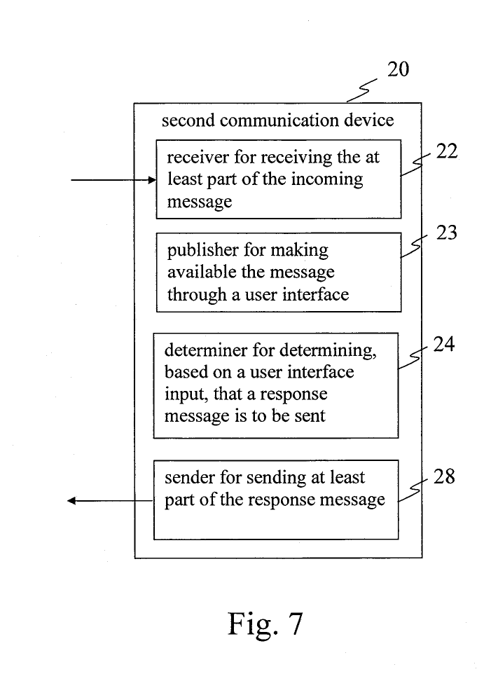

FIG. 7 schematically illustrates a second communication device 20 in one embodiment of the invention. This second device 20 illustrated in FIG. 7 differs from the one illustrated in FIG. 5 in that it includes a publisher 23 configured for making available, by the second device 20, through the user interface thereof, the at least part of the incoming message. Moreover, the determiner 24 determines, based on a user interface input, that the response message is to be sent.

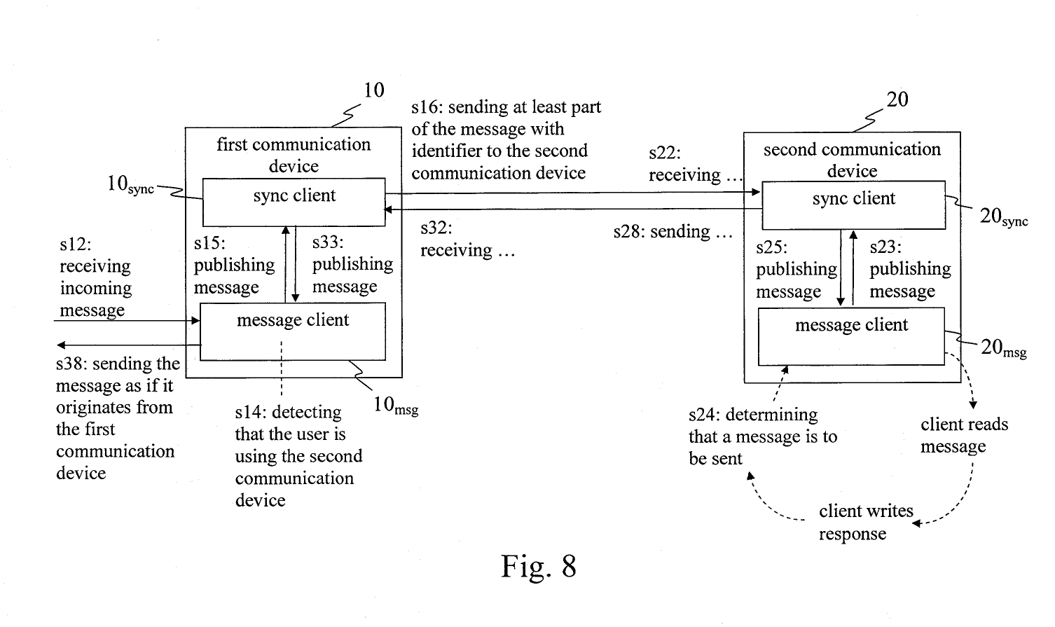

FIG. 8 schematically illustrates a communication system including a first communication device 10 and a second communication device 20, in one embodiment of the invention.

The first device 10 includes a message client 10_{msg} and a sync client 10_{sync}. Likewise, the second device 20 includes a message client 20_{msg} and a sync client 20_{sync}.

The sync clients 10_{sync}, 20_{sync} in the devices 10, 20 are configured for sending and receiving data between the two devices 10, 20 over suitable bearers including, but not limited to, mobile network data connection or internet over WIFI or mobile connection.

The message clients 10_{msg}, 20_{msg} in the first and second devices 10, 20 are configured for publishing data (messages, headers, recipients/senders) to the respective sync client 10_{sync}, 20_{sync}, as well as receiving data from them. The message client 20_{msg} has also the function to let the second device 20 reply to a message that was originally sent to the first device 10. The method also involves giving a transmitted message or a series of messages (conversation or thread) a unique identifier, for example based on time, sender and title (or any other means that keeps a unique identifier for a message or conversation).

The use of the communication system in this embodiment will now be described. An incoming message is received s12 on the first device 10 by the message client 10_{msg}. The message client 10_{msg}, which is a component of the first device 10, determines s14 that the first device 10 is currently not in use, and that instead the user is currently using the second device 20. The message client 10_{msg} in the first device 10 publishes s15 the message through the sync client 10_{sync}. The sync client 10_{sync} sends s16 at least part of the message to the sync client 20_{sync} in the second device 20, which receives s22 it. The sync client 20_{sync} publishes s25 the message (or at least part of it) to the message client 20_{msg} in the second device 20.

The user reads the message in the second device 20 (“client reads message”) and writes a response (“client writes response”) and presses “send”. The message client 20_{msg} in the second device 20 deduces s24 from the identifier that the incoming message was originally sent to the first device 10. Therefore, the second device 20 does not send the response message in a conventional manner. Rather, the second device 20 uses s25 the sync client 20_{sync}, which sends s28 the response message to the sync client 10_{sync}. Thus, the response message is sent back to the first device 10.

The sync client 10_{sync} of the first device 10 receives s32 the response message and publishes s33 it to the message client 10_{msg}. It deduces from the identifier to which addressee the response message should be sent and the message client 10_{msg} sends s38 the message in a conventional manner. The sender of the original incoming message gets a response message as if the response message originates from the first device 10, with a number that the sender knows. Confusion is avoided.

Both devices 10, 20 may have the same list of sent and received messages, draft messages etc., apart from the small interval of time that it may take to send data from one device to the other.

The sync clients may be computer program stored and configured for being executed on a communication device (such as a mobile phone). In one embodiment, the sync clients of two communication devices communicate through with a sync server stored and configured for being executed on a computer node (computer or group of computers) on a supporting network, or for instance on the internet. In one embodiment, two communication devices may also communicate (“synchronize”) directly with each other, wherein one communication device take the role of first communication device 10 and the other the role of second device 20.

As apparent from the above description, one of the advantages of the invention is that it provides means for the second communication device 20 to use the identity of the first communication device 10.

In that context, the invention may be also used in cases where the identity of a first device 10 is required for authentication for payments for example. This may be the case when the use of a subscription connected to the SIM card of one of the communication is necessary or desired for performing payments, regardless of which communication device the user is currently using. Proper authentication of the communication devices 10, 20 between each other and encryption of the communication between them may be provided. If a sync server is used, authentication of the sync client towards the sync server may be provided as well as encryption of the communications between the sync clients and server.

In one embodiment, setup options for user preferences such as receiving options (headers and text, headers only etc.), when a device acts as second communication device 20, are provided.

The physical entities according to the invention, including the first and second communication device 10, 20, may comprise or store computer programs including instructions such that, when the computer programs are executed on the physical entities, steps and procedures according to embodiments of the invention are carried out. The invention also relates to such computer programs for carrying out methods according to the invention, and to any computer-readable medium storing the computer programs for carrying out methods according to the invention.

Where the terms “determiner”, “sender”, “receiver”, “send determiner”, “second sender”, “detector”, “retriever”, “creator”, “publisher”, “message client”, “sync client” are used herewith, no restriction is made regarding how distributed these elements may be and regarding how gathered they may be. That is, the constituent elements of the above determiner, sender, receiver, second determiner, second sender, detector, retriever, creator, publisher, message client, sync client may be distributed in different software or hardware components or devices for bringing about the intended function. A plurality of distinct elements may also be gathered for providing the intended functionalities.

Any one of the above-referred elements of an apparatus may be implemented in hardware, software, field-programmable gate array (FPGA), application-specific integrated circuit (ASICs), firmware or the like.

In further embodiments of the invention, any one of the above-mentioned and/or claimed determiner, sender, receiver, second determiner, second sender, detector, retriever, creator, publisher, message client, and sync client is replaced by determining means, sending means, receiving means, second determining means, second sending means, detecting means, retrieving means, creating means, publishing means, message client processing means, and sync client processing means, respectively, or by a determining unit, sending unit, receiving unit, second determining unit, second sending unit, detecting unit, retrieving unit, creating unit, publishing unit, message client processing unit, and sync client processing unit, respectively, for performing the functions of the determiner, sender, receiver, second determiner, second sender, detector, retriever, creator, publisher, message client, and sync client.

In further embodiments of the invention, any one of the above-described steps may be implemented using computer-readable instructions, for instance in the form of computer-understandable procedures, methods or the like, in any kind of computer languages, and/or in the form of embedded software on firmware, integrated circuits or the like.

Although the present invention has been described on the basis of detailed examples, the detailed examples only serve to provide the skilled person with a better understanding, and are not intended to limit the scope of the invention. The scope of the invention is much rather defined by the appended claims.

1. Communication method for sending a message to at least one addressee using a first communication device of a user or group of users and a second communication device of the user or group of users, the method including steps of,
by the second communication device,
determining that a message is to be sent from the user or group of users to the at least one addressee; and
sending, to the first communication device, at least part of the message;
by the first communication device,
receiving, from the second communication device, the at least part of the message; and
sending, to the at least one addressee, the message with information identifying the first communication device as sender of the message.

2. Method of claim 1, further including, between the steps of, by the second communication device,
determining that a message is to be sent to the at least one addressee, and
sending, to the first communication device, at least part of the message,
a step of, by the second communication device,
determining that the message has to be sent with information identifying the first communication device as sender of the message.

3. Communication method for receiving a message and replying thereto using a first communication device of a user or group of users and a second communication device of the user or group of users, the method including steps of,
by the first communication device,
receiving an incoming message;
determining that the user or group of users is currently not using the first communication device;
sending, to the second communication device, at least part of the incoming message and an identifier of the first communication device;
by the second communication device,
receiving, from the first communication device, the at least part of the incoming message and the identifier;
the method further including the method of claim 1, wherein the message is a response message in response to the incoming message.

4. Method of claim 3, wherein the identifier of the first communication device further identifies the incoming message.

5. Method of claim 4, wherein the step of, by the second communication device, sending, to the first communication device, at least part of the response message includes sending the identifier.

6. Method of claim 5, wherein the method further includes, between the steps of, by the first communication device,
receiving, from the second communication device, the at least part of the response message, and
sending the response message to the at least one addressee with information identifying the first communication device as sender of the response message,
steps of, by the first communication device,
detecting the identifier sent with the at least part of the response message;
retrieving a copy of the incoming message; and
creating the response message based on the at least part of the response message received from the second communication device and based on the copy of the incoming message.

7. Method according to claim 3, wherein the method further includes, between the steps of, by the second communication device,
receiving, from the first communication device, the at least part of the incoming message and the identifier; and
determining that a response message is to be sent in response to the incoming message;
a step of making available, by the second communication device, through a user interface thereof, the at least part of the incoming message; and
wherein the step of determining, by the second communication device, that a response message is to be sent in response to the incoming message is based on an input on a user interface of the second communication device.

8. Method according to claim 3, wherein the step of determining, by the first communication device, that the user or group of users is currently not using the first communication device is based on a user-set parameter.

9. Method according to claim 1, wherein at least one of the first communication device and the second communication device is a mobile device.

10. Communication device, here referred to as second communication device, configured,
in cooperation with another communication device, here referred to as first communication device,
wherein both the first communication device and the second communication device are of the same user or group of users,
for sending a message to at least one addressee, the second communication device including:
a determiner configured for determining that a message is to be sent from the user or group of users to the at least one addressee; and
a sender configured for sending, to the first communication device, at least part of the message.

11. Communication device, here referred to as first communication device, configured,
in cooperation with another communication device, here referred to as second communication device,
wherein both the first communication device and the second communication device are of the same user or group of users,
for sending a message to at least one addressee, the first communication device including:
a receiver configured for receiving, from the second communication device at least part of the message; and
a sender configured for sending, sending, to the at least one addressee, the message with information identifying the first communication device as sender of the message.

12. Communication system including a first communication device according to claim 11 and a second communication device configured
in cooperation with the first communication device,
wherein both the first communication device and the second communication device are of the same user or group of users,
for sending a message to at least one addressee, the second communication device including:
a determiner configured for determining that a message is to be sent from the user or group of users to the at least one addressee; and
a sender configured for sending, to the first communication device (10), at least part of the message.

13. Communication system of claim 12, wherein
the second communication device further includes
a determiner, here referred to as second determiner, configured for determining that the message has to be sent with information identifying the first communication device as sender of the message.

14. Communication system for receiving a message and replying thereto using a first communication device of a user or group of users and a second communication device of the user or group of users,
the first communication device including
a receiver configured for receiving an incoming message;
a determiner configured for determining that the user or group of users is currently not using the first communication device;
a sender, here referred to as second sender, configured for sending, to the second communication device, at least part of the incoming message and an identifier of the first communication device;
the second communication device including
a receiver configured for receiving, from the first communication device, the at least part of the incoming message and the identifier;
the communication system further including the communication system of claim 12, wherein the message is a response message in response to the incoming message.

15. Computer program including instructions configured, when executed on a communication device, to cause the communication device to carry out those steps to be performed by one of the first communication device and the second communication device in the method according to claim 1.
